(19) United States
(12) Patent Application Publication
(10) Pub. No.: US 2021/0191415 A1
(43) Pub. Date: Jun. 24, 2021

(54) AREA PROFILE MAP LEARNING FOR ROBOTIC DEVICE

(71) Applicant: Diversey, Inc., Fort Mill, SC (US)

(72) Inventors: Aurle Y. Gagne, Mechanicsville, VA (US); David M. Knuth, JR., North Chesterfield, VA (US); Philip Scarim, Troutville, VA (US)

(21) Appl. No.: 16/720,470

(22) Filed: Dec. 19, 2019

(51) Int. Cl. G05D 1/02

(52) U.S. Cl. CPC G05D 1/0238; G05D 1/0219; G05D 2201/0203; G05D 1/0221; G05D 1/0274

(57) ABSTRACT

A robotic device is used to generate a map of a facility. A processor will receive a facility description that includes an initial path and one or both of the following: a first number of navigable openings that are positioned along the initial path, or a first number of barriers that are positioned along the initial path. The robotic device will move along the initial path. As this happens, one or more sensors of the robotic device will capture a data set of sensed characteristics of the facility. The processor will analyze the data set to detect navigable openings along the initial path, and it will assign an identifier to each navigable opening. The processor will use the identifiers of the navigable openings to develop a map of the facility that includes the navigable openings. The processor will save the map to a data store.

### BACKGROUND

Mobile robotic devices have reduced the human effort required to perform many everyday tasks. For example, automatic cleaning devices help maintain and clean surfaces, such as hardwood floors, carpet and the like. An example of such a device is disclosed in U.S. Pat. No. 9,028,617, titled “Cleaning Device with Single Tank Recycling System,” the disclosure of which is fully incorporated into this document by reference.

Users who use such devices to clean floors wish to have the machines perform their cleaning tasks in the shortest possible amount of time, while also avoiding collisions with barriers such as walls, storage/shelving units, machinery, in-store displays, and/or other obstacles. Customers also need to identify differences between adjacent areas, such as differences in floor types, as a robotic device may only be permitted to enter an area having a floor type that corresponds to the cleaning mode in which the device is operating. This often requires the mobile robotic device to be pre-loaded with a detailed map of the area(s) to be cleaned within a facility. The device will rely on this map identify and avoid known obstacles and follow a predetermined cleaning pattern. However, it is not always possible or practical for a device to obtain a detailed map before entering the facility.

In addition, learning an unknown environment can be a complex process that requires the robotic device to collect and analyze a large volume of data. Accordingly, methods and systems are needed for enabling robotic devices to more efficiently generate a map of a facility while also navigating through it.

This document describes methods and systems that are intended to provide a robotic device, such as a robotic cleaning device, the ability to more efficiently develop a map for a facility as it moves through the facility.

### SUMMARY

In various embodiments, a robotic device is used to generate a map of a facility. A processor that is part of and/or external to the robotic device will receive a facility description that includes an initial path and one or both of the following: a first number of navigable openings that are positioned along the initial path, or a first number of barriers that are positioned along the initial path. The robotic device will move along the initial path. As this happens, one or more sensors of the robotic device will capture a data set of sensed characteristics of the facility. The processor will analyze the data set to detect navigable openings along the initial path, and it will assign an identifier to each navigable opening. The processor will use the identifiers of the navigable openings to develop a map of the facility that includes the navigable openings. The processor will save the map to a data store.

In some embodiments, the facility description also includes a set of instructions for the initial path. Causing the robotic device to move along the initial path may include causing the robotic device to move around the facility according to the set of instructions.

In some embodiments, the sensed characteristics of the facility include one or more detected openings. The system may analyze the data set to detect which of the detected openings are navigable openings in the facility by, for each opening: determining a width of the opening; and determining whether the opening is navigable by determining whether the width of the opening exceeds a threshold that is larger than a width dimension of the robotic device. Identifying the width of each detected opening may include identifying a width dimension for the detected opening that is either (a) a distance from an adjacent endpoint of the initial path to a barrier that is adjacent to the navigable opening, or (b) a distance between two barriers that are adjacent to the navigable opening. Alternatively, identifying the width of each detected opening may include (i) identifying a distance between a first end of the navigable opening and a start position that is either (a) a starting point of the initial path or (b) a second end of a previous navigable opening; and (ii) identifying a distance between a second end of the navigable opening and either (a) the start position or (b) the first end of the navigable opening.

In some embodiments, the system also may analyze the data set to detect the barriers that are positioned along the initial path. For each of the barriers, the system may identify a width of the barrier. When developing the map of the facility, the system may include the barriers in the map of the facility.

In some embodiments, for one or more of the navigable openings, the system may determine whether the system has received an instruction to map an area within the navigable opening. If (and only if) the system has received an instruction to map the area within the navigable opening, the system may cause the robotic device to move into the area, As the robotic device moves within the area, one or more sensors of the robotic device may capture sensed characteristics of the area. The system may then include structural information corresponding to the sensed characteristics of the area in the map.

In some embodiments, the facility description may include the first number of barriers that are positioned along the initial path. If so, then analyzing the data set to detect each navigable opening along initial path may include: (i) detecting each barrier along the initial path; and (ii) for each detected barrier, identifying an opening that begins or ends at an endpoint of the detected barrier.

In some embodiments, the robotic device may be a robotic cleaning device. If so, the robotic cleaning device may use the map to navigate within and clean the facility. If so or alternatively, the robotic device may clean the facility while moving along the initial path and capturing the data set of sensed characteristics.

In other embodiments, in a method of generating a map of a facility using a mobile robotic device, a processor will receive a facility description that includes a number of navigable openings, a number of barriers, or both. One or more sensors of the robotic device will capture a data set of sensed characteristics of the facility while the robotic device remains in place or rotates. The processor will then analyze the data set to detect navigable openings in the facility and assign an identifier to each navigable opening. The processor will use the identifiers of the navigable openings to develop a map of the facility that includes the navigable openings, and it will save the map to a data store.

### BRIEF DESCRIPTION OF THE DRAWINGS

FIG. 1 is a block diagram showing a mobile robotic device in accordance with an aspect of the disclosure.

FIG. 2 illustrates a facility layout for a facility in which a mobile robotic device may move.

FIG. 3 illustrates an example process of generating a map for a facility according to various embodiments.

FIG. 4 illustrates an example process of generating a map for a facility according to various other embodiments.

FIG. 5 illustrates a system by which a mobile robotic device may be controlled by a remote server.

FIG. 6 illustrates example components that may be included in a mobile robotic device or a remote server.

FIG. 7 illustrates an alternate facility layout for a facility in which a mobile robotic device may move.

FIG. 8 illustrates an example process of generating a map for a facility sector such as that shown in FIG. 7.

### DETAILED DESCRIPTION

In this document, the singular forms “a,” “an,” and “the” include plural references unless the context clearly dictates otherwise. In this document, the term “comprising” means “including, but not limited to.” Unless defined otherwise, all technical and scientific terms used in this document have the same meanings as commonly understood by one of ordinary skill in the art.

When used in this document, terms such as “top” and “bottom,” “upper” and “lower”, or “front” and “rear,” are not intended to have absolute orientations but are instead intended to describe relative positions of various components with respect to each other. For example, a first component may be an “upper” component and a second component may be a “lower” component when a device of which the components are a part is oriented in a first direction. The relative orientations of the components may be reversed, or the components may be on the same plane, if the orientation of the structure that contains the components is changed. The claims are intended to include all orientations of a device containing such components.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

The terms “memory,” “memory device,” “computer-readable medium,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

A “robot” or “robotic device” is a system that is capable of autonomous movement and that performs both physical and computational activities. The physical activities may be performed using a wide variety of movable parts including various tools, such as scrub brushes, liquid applicators and vacuum systems in a robotic cleaning device. The computational activities may be performed using a suitable processor and computer readable memory devices that are part of the robot, that are external to the robot on a system that communicates with the robot by a communication signal delivered via communication technologies such as Wi-Fi, short range communication, or near field communication. The computational activities may include processing information input from various sensors or other inputs of the robotic device to perform commanded functions such as vacuuming, scrubbing, or applying water or cleaning solution to a floor. Furthermore, while robotic cleaning devices are described throughout the present disclosure, it is to be understood that the “robot” or “robotic device” is not necessarily limited to a robotic cleaning device, and may be any mobile robotic device capable of covering an area, including devices covering the area for purposes other than (or in addition to) cleaning operations.

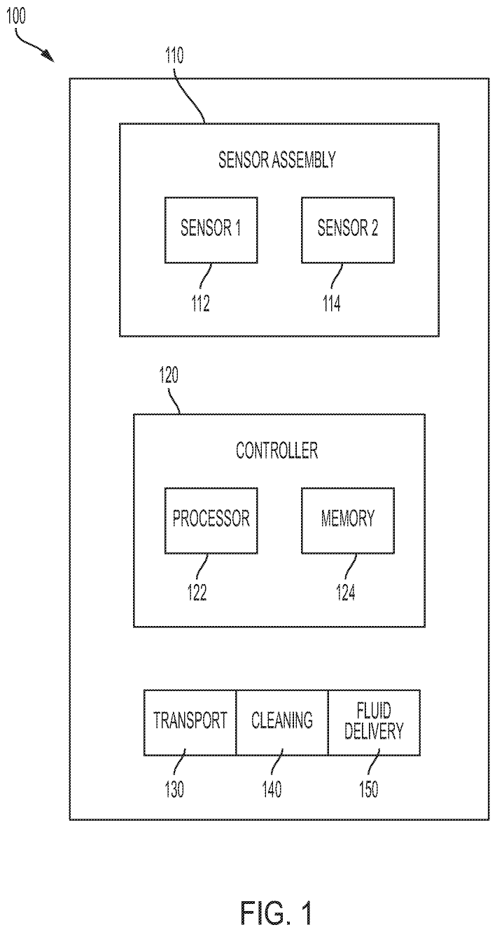

FIG. 1 is a block diagram showing a mobile robotic device 100 in accordance with an aspect of the present disclosure. As shown in FIG. 1, the robotic device 100 may include a sensor assembly 110, a controller 120 operably connected to the sensor assembly 110, and a transport assembly 130 operably connected to the controller. When the robotic device 100 is a cleaning device, it may also include elements such as a cleaning assembly 140 and a fluid delivery system 150. However, it is to be understood that robotic device 100 may omit one or both of the cleaning assembly 140 and fluid delivery system 150, and/or may include other implements. It should be noted that the elements as shown in FIG. 1 are shown by way of example only. Additional information related to robotic devices is shown in U.S. Pat. No. 6,667,592, titled “Mapped Robot System,” the content of which is fully incorporated into this document by reference.

The sensor assembly 110 may include various components such as a first sensor assembly 112 and a second sensor assembly 114, which assemblies may include a sonar assembly, a LIDAR assembly, and/or other various sensor mechanisms such as other laser-based sensors, global positioning system (GPS) devices, microwave sensors, cameras, gyroscopes, infrared (IR) sensors, structured light sensors such as structured light cameras and 3D structured light scanners, stereo cameras and other sensors that are capable of capturing information about the environment in which the robot is operating. Any combinations of these sensors may be used, and the sensors may be placed in various locations on the robotic device, such as its front, rear, or sides. The sensors will collect information about the mobile robotic device's surroundings such as coordinates, navigational information, visual information and/or the like. This document may refer to data collected by one or more of the sensors as “sensor data.” For example, if the sensor assembly includes a sonar assembly, the system may include a tunable ultrasonic piezoelectric transducer configured to transmit sound at a desired pressure level, and to receive reflected sound so that the processor may use the reflected signals to calculate a distance between the robot and an obstacle such as a wall.

If the sensor assembly includes a camera, the device may process received images to locate one or more substantially straight, curved or otherwise shaped lines in the image that may be representative of a boundary that is formed by a wall, a step up or down, a transition between flooring types, or another obstacle or edge. For example, a video camera may be able to detect a corner where an aisle of a store or storage facility meets an intersecting aisle. Similarly, a video camera may be able to detect an edge based on a variation in floor type, such as by color contrast. The mobile robotic device may use this information, optionally with information from other sensors of the device to determine its position relative to the detected edge. For example, a mobile robotic device may compare information about its current position, such as its coordinates, heading and/or the like, with information received from the video camera regarding the edge. The mobile robotic device may use this comparison to determine its position relative to the edge, its distance away from the edge and/or the like.

The controller 120 may include a processor 122 and a computer-readable medium 124 such as a hard drive, an optical drive, a flash drive, a read-only memory or a random access memory containing programming instructions that are configured to cause the processor 122 to process information and control the other elements of the robot. In addition or alternatively to an on-board memory with programming instructions, the controller may be connected to a transceiver that is capable of receiving commands from one or more external systems.

The transport assembly 130 includes a mechanical system that is configured to move the robotic device from one place to another, such as a motor, drive system, and set of wheels, rollers, or the like. The speed of the robotic device may be determined via, for example, data received from optical encoders associated with the wheels, rollers, etc. However, other means of determining the speed of the robotic device are also within the scope of this disclosure.

The cleaning assembly 140 may include cleaning elements that are configured to contact, dislodge and/or draw particles from the floor to clean the floor. Examples of such cleaning elements include a cleaning head with and a scrubber, a squeegee, a vacuum system, and one or more motors to activate these elements.

The fluid delivery system 150 may include one or more tanks for holding fresh water and/or cleaning solution that is directed to the floor scrubber and/or other components of the cleaning assembly, and/or used water and/or cleaning solution that the cleaning assembly withdraws from the floor after application. The fluid delivery system 150 also will include elements for directing fluid to, and withdrawing fluid from, the floor such as filter, a discharge line, and a pump. For example, the fluid delivery system 150 may include a fluid dispensing tank, a pump for directing fluid from the dispensing tank to the floor cleaning devices via one or more conduits, a suction assembly such as a suction pump and conduit leading from the underside of the robotic device, and a fluid receiving tank.

The components of the robotic device 100 as described may be configured to perform a wide variety of operations. The robotic device may include a processor 122 that is configured to monitor and control various operations of the robotic device 100. The robotic device also may include a memory device 124 configured to store a variety of programming instructions and/or data used by the processor 122 as well as the other components of the robotic device 100.

The block diagram of FIG. 1 illustrates various operating components of the robotic device 100. It should be appreciated that the operating components of the robotic device 100, or select operating components of the robotic device 100, may be encased or enclosed in a suitable body or body portion. Alternatively, it should be appreciated that the operating components of the robotic device 100 may simply be suitably disposed on a support framework or structure.

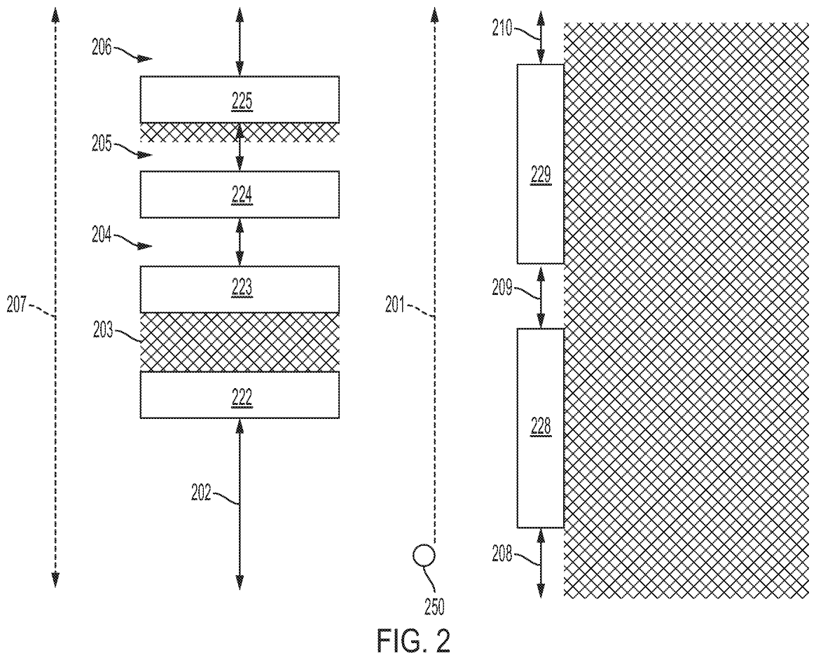

FIG. 2 illustrates an example layout of a facility in which a mobile robotic device 250, such as a robotic cleaning device, may move. The facility may be any structure in which a robotic device may move, such as a warehouse, a retail store or an office space. The facility includes an initial path 201 along which the robotic device 250 will travel. The initial path 201 may be an aisle, a corridor or hallway, or another area of the facility along which one or more barriers and one or more openings to other areas are positioned. Along the left side of the initial path 201 are four barriers 222-225 such as walls, shelving units, changes in floor type or other physical structures through which the robotic device could not travel or is not permitted to travel in specified operations (such as particular floor cleaning modes). Open areas 203-205 through which the robotic device could travel exist between each of the barriers 222-225. Open area 202 also exists between the starting point of the initial path 201 and the first barrier 222, while another open area 206 exists between the final point of the initial path 201 and barrier 225. Similarly, barriers 228 and 229 are positioned on the right side of the initial path 201, open area 209 is positioned between barriers 228 and 229, and open areas 208 and 201 are positioned between one of the barriers (228 or 229) and the barrier's corresponding closest endpoint of the initial path 201.

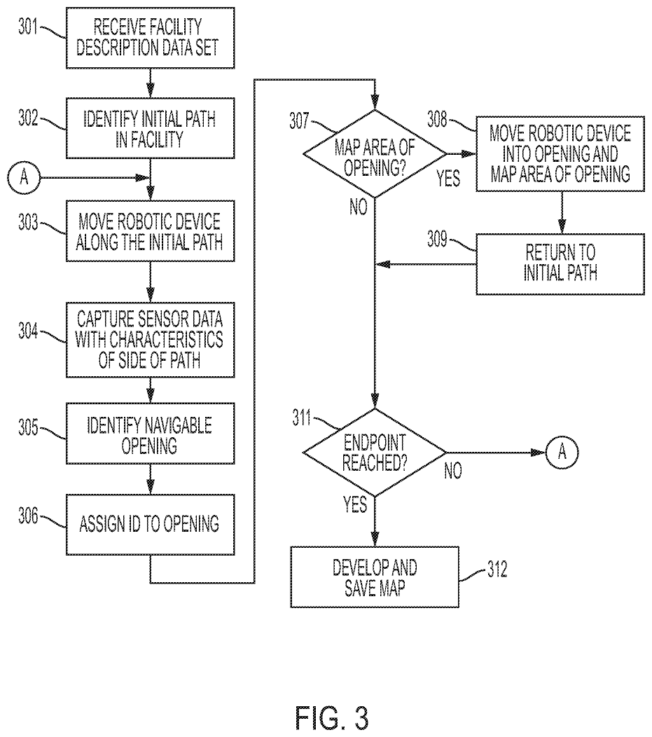

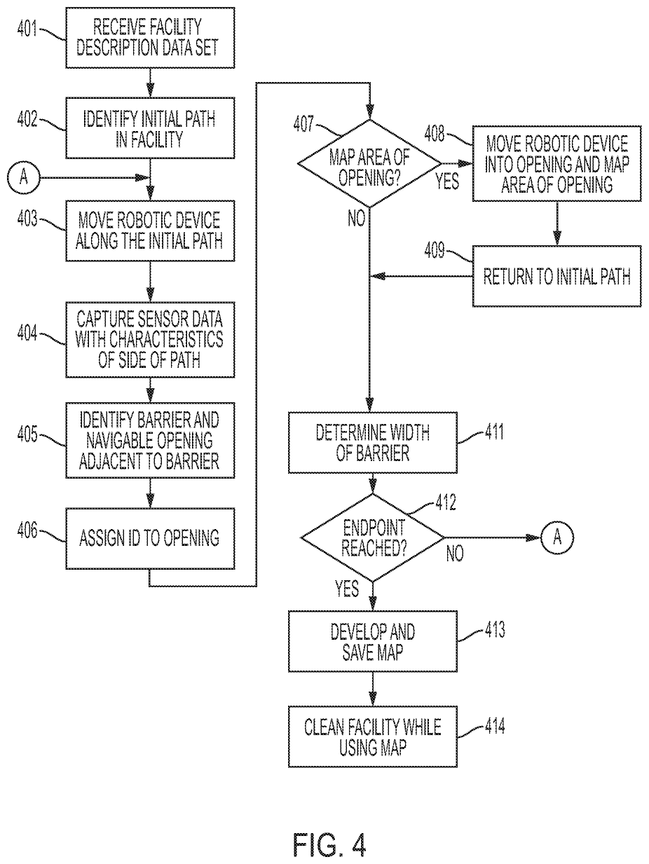

FIG. 3 illustrates a process by which a system that includes a robotic device may generate a map of a facility such as that shown in FIG. 2. In FIG. 3, in step 301 a processor will receive a basic facility description data set. At this step, as well as in each step of the process described below, the processor may be integral with the robotic device, external to the robotic device (such as in an external controller and/or cloud-based server), or a combination of these. The basic facility description may include the initial path and instructions for an acquisition method to moving the device along the initial path and acquire data about the facility. The data set also may include a number of navigable openings that are positioned on one or both sides (right or left) of the initial path. Alternatively or in addition, as will be discussed below in the context of FIG. 4, the basic facility description data set may include a number of barriers that are positioned on one or both sides (right or left) of the initial path. As with the initial path described below, the system may receive the number of barriers or openings as part of a data file, via analysis of sensed data, or by manual input via a user interface of a computing device that is integral with or in communication with the robotic device or other processing components of the system. The data set may include only the numbers; it does not need to include dimensions for the openings or barriers for the purposes of this disclosure, although systems that also receive dimension data are not excluded from this disclosure.

In step 302 the system will identify an initial path in the facility (such as path 201 in FIG. 2). The initial path is a set of instructions for traversing a section of the facility. For example, an initial path may include an instruction set to do any of the following: (i) proceed straight for a known distance; (ii) proceed straight until the robot is within a set distance from a detected wall; (iii) proceed straight until the robot has detected x number of 5 openings on the left or right. An initial path also may be more complex, such as (1) proceed straight until the robot has detected a transition in the flooring, then (2) follow the transition on the right side of the machine until an opening on the right is detected, then (3) proceed to the center of an area and spin in place. Other paths may include instructions to follow a wall on the right until the robot returns to a start position, or follow a wall on the left until the robot returns to a start position.

The system may receive the initial path as part of the basic site description (in other words, concurrently with step 301 above) in a data file, by using one or more sensors (such as cameras, radar or LIDAR), or by manual input. Alternatively, the system may develop the initial path using one or more sensors to identify a first open area (such as that associated with path 201) along with the robotic device may travel for at least a minimum threshold distance. Such sensors may be any of the components of an onboard sensor assembly 110 as described in FIG. 1, such as cameras and image processing software. In addition or alternatively, the sensors may include external sensors, such as one or more cameras positioned within the facility. The system will identify endpoints for the initial path, such as a starting point for the initial path (example: the current location of the robotic device) and a final point for the initial path (examples: a location at which an obstacle is detected in the path, or a maximum threshold distance from the starting point).

In step 303, the processor will then cause the robotic device to move along the initial path. As the robotic device moves along the initial path, at step 304 one or more sensors of the robotic device will capture a data set of sensed characteristics of the facility on one or both sides of the initial path. The processor will analyze the data set at step 305 to detect the navigable openings for one or both sides, along with one or more barriers that are positioned between any of the navigable openings. The system will do this using any now or to be known object detection techniques. For example, the processor may analyze digital image streams from a camera and using any now or to be known edge detection technique to detect the presence or absence of boundaries within a certain distance from the path. The processor also may analyze radar or sonar data received from a radar or sonar sensor to identify locations where reflected signals are returned to the sensor within a time period that is below a threshold that corresponds to an expected time period for a boundary to be present. In this situation, the location of any boundary may be associated with a barrier, and the location where any boundary is not present may be associated with an opening.

To determine whether an opening is navigable, the system will determine a width for each detected opening (step 310). The width may simply be a width dimension from start to finish (i.e., distance between two adjacent barriers as with areas 203-205 of FIG. 2, or distance between an adjacent barrier to the closest endpoint of the initial path if only one adjacent barrier exists as with areas 202 and 206 of FIG. 2.) Alternatively, the width may be a distance relative to a starting point, such as (i) a distance between a first end of the navigable opening and a starting point either (a) a starting point of the initial path or (b) a second end of a previous navigable opening, along with (i) a distance between a second end of the navigable opening and either the starting point or the first end of the navigable opening. The system will determine whether the opening is navigable by assessing whether the opening's detected width exceeds a threshold size that is more than a lateral dimension of the robot (such as at least 10 percent wider than the width of the robot's width).

For each of the navigable openings, the system will assign an identifier to the navigable opening (step 306). The identifier may be a code that serves to identify the opening's position along the initial path with respect to the starting point. For example, referring to FIG. 2, the six openings on the left side of the initial path 201 are numerically identified as areas 202, 203, 204, 205, and 206, while the three openings on the right side of the initial path 201 are numerically identified as areas 208, 209 and 210. Other identification formats may be used, such as L1-L6 for the left side openings, and R1-R3 for the right side openings.

Optionally, the system also may determine a width for each barrier (step 311). As with the width determination for navigable openings, the system may determine the width of each barrier simply as a width dimension from end to end, or distance between an adjacent opening and the closest endpoint of the initial path if the barrier overlaps the endpoint.

After identifying each navigable opening on a side of the path and assigning the identifier to the opening, the system may determine whether the system has reached the end of its path or if the identifier corresponds to the received number of openings for the side (step 312). In other words, the system will determine whether the opening is the final expected opening along the initial path for that side. In the example shown in FIG. 2, if the received number for the left side is 5 and the identifiers for the left side are L1-L5, then when the system assigns L5 to a navigable opening it will determine that area L5 is the final navigable opening for the left side. If the opening's identifier is not the final opening, the system will return to step 303 and continue to move the robotic device along the initial path to capture data and identify additional openings.

If the opening is the final opening in step 312, the system may continue along the initial path until the path's ending condition is met (such as until reaching a certain distance, or until detecting an obstacle). Optionally, detection of the final opening may be the ending condition. Optionally, multiple passes along the openings may be required before the end of the path is reached. After the end of the path has been reached (or incrementally while traversing the path), the system will develop a map by saving the positions and widths of each of the openings to a map file, and saving the map file in a data store (step 313). The map will thus include data that represents the facility layout (such as that of FIG. 2). Example map generation processes are disclosed in: U.S. Pat. No. 8,958,937 titled “Mapped robot cleaning system,” as well as in U.S. Pat. No. 9,609,991 titled “Methods and systems for movement of an automatic cleaning device using video signal,” the disclosures of which are fully incorporated into this document by reference.

Optionally, the system also may determine whether it should map areas within each opening (step 307). The system may do this incrementally, as it encounters each navigable opening. Alternatively, the system may go back and determine whether to map areas within navigable openings after it has completed traversing the initial path. Either way, when the system determines that it should map an area within an opening, it will move the robotic device into the opening and perform a defined map acquisition process in the area. For example, its sensors may collect characteristics of the area to identify structural details for the area (openings, barriers, boundaries, and the like as discussed above) for inclusion in the map the area discovered during the acquisition process defined by the acquisition method in the facility description dataset (step 308). The system may do this using the same processes as are described in this document, or using any other data collection and map generation methods. When it has completed mapping that area, the system will return to the initial path (step 309) and then continue moving along the initial path, either to the next navigable opening or to the end of the initial path if no more openings exist.

To determine whether to map areas within an opening (step 307), the system will analyze the initial site description to determine whether the site description indicates that the area within the opening should be mapped. In some embodiments, a site description may include an identifier for each opening indicating whether it should be mapped. Alternatively, the system may default to either (a) mapping each opening's area unless instructed otherwise, or (b) not mapping any opening's area unless instructed otherwise. Either way, by using the site description to determine that only certain corridors need to be mapped, the system can more quickly map the important corridors of a facility and not bother with corridors for which the site description indicated that a map is not required. For example, in FIG. 2 the system has been instructed to not map area 203, so area 203 is illustrated as not mapped.

Optionally, some areas may be designated for only partial mapping. If so, an area within an opening may be designated with an “offset,” which is a distance from an endpoint of the area to an interior position in the area that should be excluded from the mapping process. In FIG. 2, area 205 includes an offset section that was not mapped; this offset section is adjacent to barrier 225 within area 205. Alternatively, an area may be fully assessed but only partially designated for use by the robotic device in a particular process, such as a cleaning action. If so, then the area may be designated for partial cleaning or other processing, and the offset section may be areas that will not be cleaned or otherwise processed.

A site description may use any suitable format. For example, the site description may be a sequence of numbers, an example of which is:

(1, (0 (2,1), (3,0), (4,1), (5,1,0,0.5), (6, ((7,1))), (1 (8,0), (9,0), (10,0))).

In this example, the number 1 in the first order indicates that the initial path is area 1. In the second order, 0 means left and 1 means right. A third order indicates whether each opening should be mapped (with 1 being “map” and 0 being “don't map”), either in full or in part. Therefore, in the example above, along the left side (0) there are openings designated as areas 2, 3 and 4. The (2,1) and (4,1) indicate that areas 2 and 4 should be mapped with no offsets, while the (3,0) indicates that area 3 should not be mapped. The (5,1,0.5), indicates that area 5 should be mapped, but that during operation the device should maintain a 0.5 offset from the area's right side wall. The (6, (7,1))), indicates that areas 6 and 7 should be mapped. Finally, (1 (8,0), (9,0), (10,0)) indicates that to the right (1) of area 1, areas 8, 9 and 10 exist but none of them should be mapped.

Returning to FIG. 3, when the map is developed, if the system's robotic device is a robotic cleaning device, the system also may then use the map to clean the facility (step 314). In addition, in some embodiments while developing the map the robotic cleaning device may clean the facility while moving the robotic device along the initial path and or areas within navigable openings. The system may do this by operating a transport system of the robotic device, along with one or more cleaning systems such as a vacuum, scrubber, fluid applicator, fluid suction, or other systems while moving through the facility. Examples cleaning systems and methods of operating them are disclosed in U.S. Pat. No. 9,028,617 titled “Cleaning device with single tank recycling system,” and U.S. Patent Application Pub. No. 2019/0008350 titled “Floor cleaning device,” the disclosures of which are fully incorporated into this document by reference.

FIG. 4 illustrates an alternate embodiment in which instead of receiving a number of navigable openings in the site description, the system receives a number of barriers in the site description. In FIG. 4, as in FIG. 3, the processor will receive or otherwise access a facility description data set (step 401) and identify an initial path in the facility (step 402). However, instead of (or in addition to) receiving a number of navigable openings in the basic facility description data set, the system will receive a number of barriers that are positioned on one or both sides (right or left) of the initial path.

In step 403, the processor will then cause the robotic device to move along the initial path. As the robotic device moves along the initial path, at step 404 one or more sensors of the robotic device will capture a data set of sensed characteristics of the facility on one or both sides of the initial path. The processor will analyze the data set at step 405 to detect the barriers for one or both sides, along with one or more navigable openings that are adjacent to each barrier. The system will do this using any now or to be known object detection techniques, such as those described above in the discussion of FIG. 3. The system will determine whether a particular opening is navigable based in whether its width (i.e., the distance between barriers) exceeds a navigation threshold. Optionally, the system also may determine a width for each barrier (step 411).

The process then continues as it did for FIG. 3. For each of the navigable openings, the system optionally may assign an identifier to the navigable opening (step 406). The identifier may be a code that serves to identify the opening's position along the initial path with respect to the starting point.

After identifying each barrier on a side of the path and assigning the identifier to the opening, the system will determine whether the end of the initial path has been reached (such as, for example, if the system has detected a number of barriers that match the received number of barriers in the facility description data set) (step 412). If all barriers have not yet been detected along a side, or if the initial path's ending condition is not yet reached, the system will return to step 403 and continue to move the robotic device along the initial path to capture data and identify additional barriers and openings.

For example, one acquisition method may be to drive around a room in a counterclockwise direction. This would provide an initial path having four components (one for each sidewall of the room. As the robot travels along the walls, it will detect openings, always to the right side of the wall when moving in the counterclockwise direction. The first pass would be the openings to the right of the area, the second pass would be the openings at the end of the area, the third pass would be the openings to the left of the area and the fourth pass would be the openings at the front of the area. Other acquisition method examples include following each wall along the right side of the robotic device until the device returns to its starting point.

If step 412 determines that the endpoint of the initial path has been reached (such as by determining that all barriers have been detected), or even incrementally as the process proceeds, the system may develop a map by saving the positions and widths of each of the openings to a map file, and saving the map file in a data store (step 413). The map will thus include data that represents the facility.

Optionally, as with the embodiment of FIG. 3, the system also may determine whether it should map areas within each opening (step 407). When the system determines that it should map an area within an opening, it will move the robotic device into the opening and perform the defined acquisition method in the area. Its sensors will collect characteristics of the area to identify structural details for the area for inclusion in the map the area discovered during the acquisition process defined by the acquisition method in the facility description dataset (step 408). When it has completed mapping that area, the system will return to the initial path (step 409) and then continue moving along the initial path, either to the next navigable opening or to the end of the initial path if no more openings exist.

As with the previous embodiment, if the system's robotic device is a robotic cleaning device, the system also may then use the map to clean the facility (step 414), While developing the map, the robotic cleaning device also may clean the facility.

In the embodiments described above, with only minimal initial information (specifically, the initial path, and the number of openings or barriers on the right and/or left side of the path) the system can use the processes described above to more quickly and efficiently develop a map of the facility.

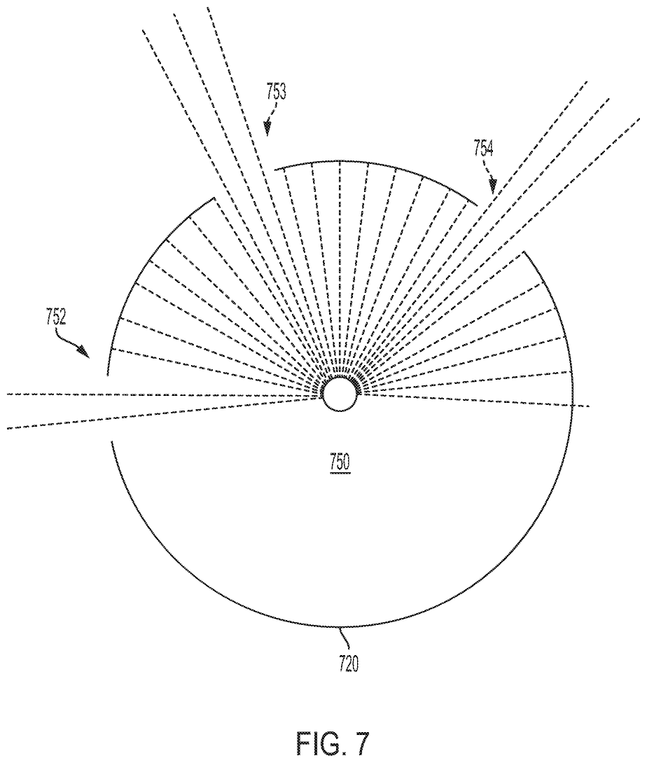

FIG. 7 illustrates an alternate example layout of a sector of a facility in which a mobile robotic device 750, such as a robotic cleaning device, may move. In this embodiment, the robotic device may not need to follow an initial path, or it could perform certain mapping functions before starting along an initial path. Thus, the layout shown in FIG. 7 could represent a starting point for a robotic device that later follows an initial path such as that shown in FIG. 2, or it may represent a full mapping process. The facility includes one or more barriers 720 such as walls, shelving units, changes in floor type or other physical structures through which the robotic device could not travel or is not permitted to travel in specified operations (such as particular floor cleaning modes). The barrier(s) 720 may be a circular barrier as shown, or multiple barriers may form a square, rectangle or other shaped structure. Open areas 751-753 through which the robotic device could travel exist between or within the barrier(s) 720.

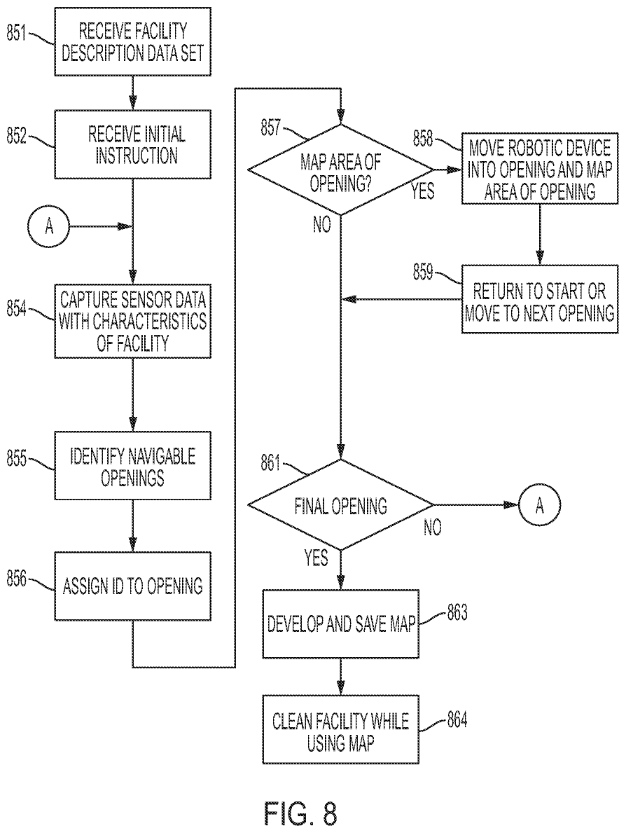

FIG. 8 illustrates a process by which a system that includes a robotic device may generate a map of a facility sector such as that shown in FIG. 7. In FIG. 8, in step 851 a processor will receive a basic facility description data set. As with previous embodiments, the data set also may include a number of navigable openings or barriers that are positioned along the sidewalls or other barriers of the facility.

In step 852 the system will identify an initial instruction set for sensing data about the area of facility around the robotic device. Instead of causing the robotic device to travel along the initial path (or before starting along the initial path, or at any point along the initial path), the initial instruction set will cause the robotic device to use one or more sensors to capture (at step 854) a data set of sensed characteristics of the facility around the robotic device, especially along the sidewalls or other barriers. In step 854, while capturing the data the robotic device may remain in place, or the robotic device may rotate to capture data from multiple angles around the robot. (For example, FIG. 7 shows a robotic device capturing data corresponding to an approximately 180° field of view in front of the device). The processor will analyze the data set at step 855 to detect the navigable openings and/or barriers that are positioned around the robotic device, using processes such as those described in previous embodiments. As with previous embodiments, to determine whether an opening is navigable, the system may determine a width for each detected opening, and the system may then assess whether opening's detected width exceeds a threshold size that is more than a lateral dimension of the robot.

For each of the navigable openings, the system will assign an identifier to the navigable opening (step 856). The identifier may be a code that serves to identify the opening's position along the initial path with respect to the starting point. Other identification formats may be used.

The system will repeat this process until all navigable openings have been identified (step 861). The system may determine whether the system identified all navigable openings if the number of openings detected corresponds to the number in the facility description data set, or if the robotic device has sensed the entire environment that is within its sensors' field of view, or by other methods.

Optionally, the system also may determine whether it should map areas within each opening (step 857). The system may do this incrementally, as it encounters each navigable opening. Alternatively, the system may go back and determine whether to map areas within navigable openings after it has identified all openings. Either way, when the system determines that it should map an area within an opening, it will move the robotic device into the opening and perform a defined map acquisition process in the area, as described in previous embodiments. When it has completed mapping an area, the system may return to the starting point or move to the next navigable opening (step 859).

When all navigable openings have been identified and area maps completed, the system may develop a map by saving the positions and widths of each of the openings to a map file, and saving the map file in a data store (step 863). The map will thus include data that represents the facility layout. Example map generation processes were discussed above.

Optionally, as with previous embodiments, if the system's robotic device is a robotic cleaning device, the system may then use the map to clean the facility (step 864). The robotic device also may clean the facility while moving into the navigable openings to develop the map.

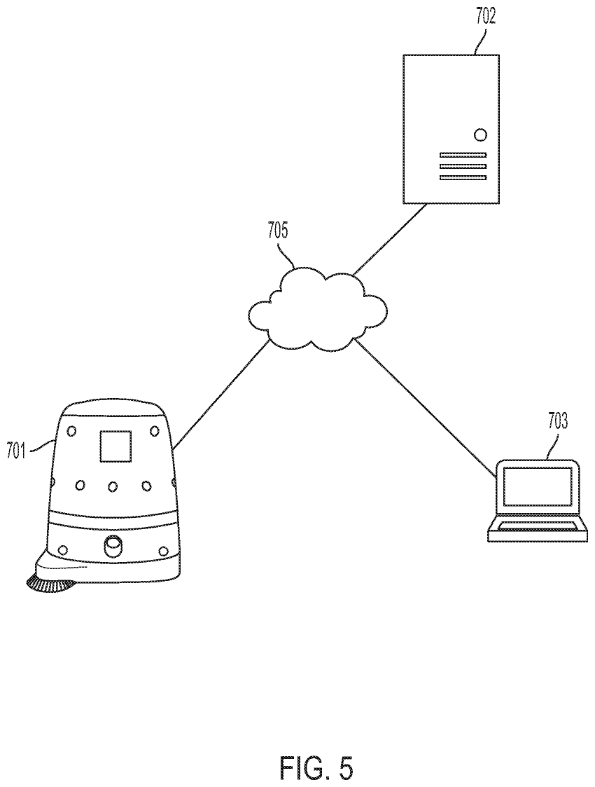

Referring to FIG. 5, it is to be understood that any of the processing operations described above may be performed by a robotic device 701 itself, or the robotic device 701 may transmit its sensor data to a remote server 702 or a local electronic device 703 that is in electronic communication with the robotic device 701 via one or more communication networks 705.

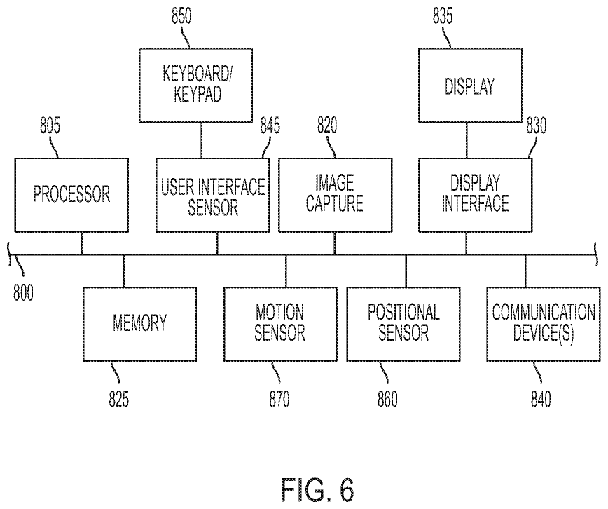

FIG. 6 depicts an example of internal hardware that may be included in any of the electronic components of the system, such as the mobile robotic device or a server that controls the mobile robotic device. An electrical bus 800 serves as an information highway interconnecting the other illustrated components of the hardware. Processor 805 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 825. A memory device may include a single device or a collection of devices across which data and/or instructions are stored.

An optional display interface 830 may permit information from the bus 800 to be displayed on a display device 835 in visual, graphic or alphanumeric format. An audio interface and audio output (such as a speaker) also may be provided. Communication with external devices may occur using various communication devices such as a wireless antenna 844, an RFID tag and/or short-range or near-field communication transceiver 842, each of which may optionally communicatively connect with other components of the system. The communication device 840 may be configured to be communicatively attached to a communications network, such as the Internet, a local area network or a cellular telephone data network.

The hardware may also include a user interface sensor 845 that allows for receipt of data from input devices 850 such as a keyboard, a mouse, a joystick, a touchscreen, a touch pad, a remote control, a pointing device and/or microphone. Digital image frames also may be received from a camera (image sensor 820) that can capture video and/or still images. The system also may include a positional sensor 860 and/or motion sensor 870 to detect position and movement of the device. Examples of motion sensors 870 include gyroscopes or accelerometers. Examples of positional sensors 860 include a GPS sensor device that receives positional data from an external GPS network, and/or the other sensors described above such as a sonar assembly or LIDAR assembly.

The following U.S. patent documents are fully incorporated into this patent document by reference: (1) U.S. Pat. No. 8,958,937, titled “Cleaning Machine with Collision Prevention”; (2) U.S. Pat. No. 8,679,260, titled “Method and System for Movement of an Automatic Cleaning Device using Video Signal”; (3) U.S. Pat. No. 8,532,860, titled “Method and System for Automatic Yield to High Priority Traffic”; and (4) U.S. Pat. No. 8,423,225, titled Method and System for Movement of Robotic Device using Video Signal.

It will be appreciated that the above-disclosed and other features and functions may be combined into many other different systems or applications. All such applications and alternatives are also intended to be encompassed by the disclosure of this patent document.

1. A method of generating a map of a facility using a mobile robotic device, the method comprising:
by a processor, receiving a facility description comprising an initial path and one or both of the following: a first number of navigable openings that are positioned along the initial path, or a first number of barriers that are positioned along the initial path;
by the processor, causing the robotic device to move along the initial path;
by one or more sensors of the robotic device as the robotic device moves along the initial path, capturing a data set of sensed characteristics of the facility; and
by the processor:
analyzing the data set to detect navigable openings along the initial path,
for each of the navigable openings, assigning an identifier to the navigable opening,
using the identifiers of the navigable openings to develop a map of the facility that includes the navigable openings, and
saving the map to a data store.

2. The method of claim 1, wherein:
the facility description further comprises a set of instructions for the initial path, and causing the robotic device to move along the initial path comprise causing the robotic device to move around the facility according to the set of instructions.

3. The method of claim 1, wherein:
the sensed characteristics of the facility comprise a plurality of openings; and
analyzing the data set to detect the navigable openings in the facility comprises, for each opening in the sensed characteristics:
determining a width of the opening, and
determining whether the opening is navigable by determining whether the width of the opening exceeds a threshold that is larger than a width dimension of the robotic device.

4. The method of claim 3 wherein identifying the width of each opening comprises identifying a width dimension for the opening that is either (a) a distance from an adjacent endpoint of the initial path to a barrier that is adjacent to the navigable opening, or (b) a distance between two barriers that are adjacent to the navigable opening.

5. The method of claim 3 wherein identifying the width of each opening in the sensed characteristics comprises:
(i) identifying a distance between a first end of the navigable opening and a start position that is either (a) a starting point of the initial path or (b) a second end of a previous navigable opening; and
(ii) identifying a distance between a second end of the navigable opening and either (a) the start position or (b) the first end of the navigable opening.

6. The method of claim 1, further comprising, by the processor:
analyzing the data set to detect the barriers that are positioned along the initial path;
for each of the barriers, identifying a width of the barrier; and
when developing the map of the facility, also including the barriers in the map of the facility.

7. The method of claim 1 further comprising, by the processor, for one or more of the navigable openings:
determining whether the system has received an instruction to map an area within the navigable opening; and
only if the system has received an instruction to map the area within the navigable opening:
causing the robotic device to move into the area,
by one or more sensors of the robotic device as the robotic device moves within the area, capturing sensed characteristics of the area, and
including structural information corresponding to the sensed characteristics of the area in the map.

8. The method of claim 1, wherein:
the facility description comprises the first number of barriers that are positioned along the initial path; and
analyzing the data set to detect each navigable opening along initial path comprises:
detecting each barrier along the initial path, and
for each detected barrier, identifying an opening that begins or ends at an endpoint of the detected barrier.

9. The method of claim 1, wherein the mobile robotic device comprises a robotic cleaning device, and the method further comprises, by the mobile robotic device, using the map to navigate within and clean the facility.

10. The method of claim 1, wherein the mobile robotic device comprises a robotic cleaning device, and the method further comprises, by the mobile robotic device, cleaning the facility while moving along the initial path and capturing the data set of sensed characteristics.

11. A system for generating a map of a facility, the system comprising:
a robotic device comprising a transport assembly, a plurality of sensors and a processor;
a memory containing programming instructions that are configured to cause the processor to:
receive a facility description comprising an initial path and one or both of the following: a first number of navigable openings that are positioned along the initial path, or a first number of barriers that are positioned along the initial path,
cause the transport assembly to move the robotic device along the initial path,
receive, from the sensors, a data set of sensed characteristics of the facility,
analyze the data set to detect navigable openings along the initial path,
for each of the navigable openings, assign an identifier to the navigable opening, and
use the identifiers of the navigable openings to develop a map of the facility that includes the navigable openings, and
save the map to a data store.

12. The system of claim 11, wherein:
the facility description further comprises a set of instructions for the initial path;
the instructions to cause the transport assembly to move the robotic device along the initial path comprise instructions to move the robotic device around the facility according to the set of instructions for the initial path.

13. The system of claim 11, wherein:
the sensed characteristics of the facility comprise a plurality of openings; and
the instructions to analyze the data set to detect the navigable openings in the facility comprise instructions to, for each opening in the sensed characteristics:
determine a width of the opening, and
determine whether the opening is navigable by determining whether the width of the opening exceeds a threshold that is larger than a width dimension of the robotic device.

14. The system of claim 13 wherein the instructions to identify the width of each opening comprise instructions to identify a width dimension for the opening that is either (a) a distance from an adjacent endpoint of the initial path to a barrier that is adjacent to the navigable opening, or (b) a distance between two barriers that are adjacent to the navigable opening.

15. The system of claim 13 wherein the instructions to identify the width of each opening in the sensed characteristics comprise instructions to:
(i) identify a distance between a first end of the navigable opening and a start position that is either (a) a starting point of the initial path or (b) a second end of a previous navigable opening; and
(ii) identify a distance between a second end of the navigable opening and either (a) the start position or (b) the first end the navigable opening.

16. The system of claim 11, further comprising additional programming instructions that are configured to cause the processor to:
analyze the data set to detect the barriers that are positioned along the initial path;
for each of the barriers, identify a width of the barrier; and
when developing the map of the facility, also include the barriers in the map of the facility.

17. The system of claim 11 further comprising additional programming instructions that are configured to cause the processor to, for one or more of the navigable openings:
determine whether the system has received an instruction to map an area within the navigable opening; and
only if the system has received an instruction to map the area within the navigable opening:
cause the robotic device to move into the area,
by one or more sensors of the robotic device as the robotic device moves within the area, capture sensed characteristics of the area, and
include structural information corresponding to the sensed characteristics of the area in the map.

18. The system of claim 11, wherein:
the facility description comprises the first number of barriers that are positioned along the initial path; and
the instructions to analyze the data set to detect each navigable opening along initial path comprise instructions to:
detect each barrier along the initial path, and
for each detected barrier, identify an opening that begins or ends at an endpoint of the detected barrier.

19. The system of claim 11, wherein:
the robotic device comprises a robotic cleaning device; and
the system further comprises additional programming instructions that are configured to cause robotic cleaning device to use the map to navigate within and clean the facility.

20. The system of claim 11, wherein:
the mobile robotic device comprises a robotic cleaning device; and
the system further comprises additional programming instructions that are configured to cause robotic cleaning device to clean the facility while moving along the initial path and capturing the data set of sensed characteristics.

21. A method of generating a map of a facility using a mobile robotic device, the method comprising:
by a processor, receiving a facility description comprising a number of navigable openings, a number of barriers, or both;
by one or more sensors of the robotic device, capturing a data set of sensed characteristics of the facility; and
by the processor:
analyzing the data set to detect navigable openings in the facility,
for each of the navigable openings, assigning an identifier to the navigable opening,
using the identifiers of the navigable openings to develop a map of the facility that includes the navigable openings, and
saving the map to a data store.

22. The method of claim 21, wherein the method further comprises, as the one or more sensors of the robotic device capture the data set, rotating the robotic device to sense characteristics of the facility from multiple angles around the robotic device.

23. The method of claim 21, wherein:
the sensed characteristics of the facility comprise a plurality of openings; and
analyzing the data set to detect the navigable openings in the facility comprises, for each opening in the sensed characteristics:
determining a width of the opening, and
determining whether the opening is navigable by determining whether the width of the opening exceeds a threshold that is larger than a width dimension of the robotic device.

24. The method of claim 21 further comprising, by the processor, for one or more of the navigable openings:
determining whether the system has received an instruction to map an area within the navigable opening; and
only if the system has received an instruction to map the area within the navigable opening:
causing the robotic device to move into the area,
by one or more sensors of the robotic device as the robotic device moves within the area, capturing sensed characteristics of the area, and
including structural information corresponding to the sensed characteristics of the area in the map.

25. The method of claim 21, wherein the mobile robotic device comprises a robotic cleaning device, and the method further comprises, by the mobile robotic device, using the map to navigate within and clean the facility.
